(19) United States
(12) Patent Application Publication
(10) Pub. No.: US 2023/0126696 A1
(43) Pub. Date: Apr. 27, 2023

(54) LANE CHANGE METHOD AND SYSTEM, STORAGE MEDIUM, AND VEHICLE

(71) Applicant: NIO TECHNOLOGY (ANHUI) CO., LTD, Hefei City (CN)

(72) Inventors: Ping ZHOU, Shanghai (CN); Sichen SUN, Shanghai (CN)

(21) Appl. No.: 18/049,101

(22) Filed: Oct. 24, 2022

(30) Foreign Application Priority Data
Oct. 27, 2021 (CN) 202111254514.6

(51) Int. Cl. B60W 30/18; G06N 3/04

(52) U.S. Cl. CPC B60W 30/18163; G06N 3/0445; B60W 2520/10; B60W 2552/10; B60W 2554/4041; B60W 2554/4042; B60W 2554/4043; B60W 2554/801; B60W 2554/802; B60W 2552/30

(57) ABSTRACT

The disclosure relates to a lane change method and system, a storage medium, and a vehicle. The lane change method includes the following steps: receiving consecutive frames of condition information, the condition information including velocity information of a current vehicle, state information of an adjacent vehicle, and lane information; with the condition information as an input to a neural network, processing the condition information by means of the neural network, to obtain an initial lane change strategy; and correcting the initial lane change strategy based on a predetermined rule and the condition information, to generate and output a corrected lane change strategy. According to this lane change method, intelligent, safe and efficient lane change may be achieved during an autonomous driving or driving assistance process.

### CROSS-REFERENCE TO RELATED APPLICATIONS

This application claims the benefit of China Patent Application No. 202111254514.6 filed Oct. 27, 2021, the entire contents of which are incorporated herein by reference in its entirety.

### TECHNICAL FIELD

The disclosure relates to the field of autonomous driving/driving assistance of vehicles, and in particular, to a lane change method, a lane change system, a storage medium, and a vehicle.

### BACKGROUND

Lane change is a common decision-making behavior during an autonomous driving (or driving assistance, similarly hereinafter) process. How to make an intelligent and safe lane change decision in a complex and variable environment is an important topic of autonomous driving, and also one of important indicators for autonomous driving technologies to reach a higher level. In an actual driving scenario, a current vehicle is in a highly interactive state with the surrounding environment, and surrounding vehicles may also have driving behaviors such as acceleration, deceleration, and lane change, which imposes high requirements on a decision system (in particular, an intelligent lane change function) for autonomous driving.

In the prior art, there are solutions to generating an intelligent lane change decision in the following ways. One solution is to achieve lane change by means of artificially designed rules. However, due to excessively complex driving scenarios, lane change conditions cannot be exhausted by means of the rules. Therefore, this solution is difficult to implement in actual applications. Another solution is to establish a machine learning model for lane change decisions by using machine learning techniques, and then make the intelligent lane change decision in different scenarios by means of this model.

### BRIEF SUMMARY

Embodiments of the disclosure provide a lane change method, a lane change system, a storage medium, and a vehicle, thereby achieving intelligent, safe and efficient lane change during an autonomous driving or driving assistance process.

According to an aspect of the disclosure, there is provided a lane change method. The method includes the following steps: receiving condition information, the condition information including velocity information of a current vehicle, state information of an adjacent vehicle, and lane information; with the condition information as an input to a neural network, processing the condition information by means of the neural network, to obtain an initial lane change strategy; and correcting the initial lane change strategy based on a predetermined rule and the condition information, to generate and output a corrected lane change strategy.

In some embodiments of the disclosure, optionally, the adjacent vehicle includes a neighboring vehicle in the front, rear, left, right, left front, right front, left rear, or right rear in a traveling direction of the current vehicle.

In some embodiments of the disclosure, optionally, the state information includes: a lateral velocity and a longitudinal velocity of the adjacent vehicle, and a lateral distance and a longitudinal distance between the adjacent vehicle and the current vehicle.

In some embodiments of the disclosure, optionally, the lane information includes coefficients of fitting curves of the lane where the current vehicle is located and its adjacent lanes.

In some embodiments of the disclosure, optionally, the neural network is a long short-term memory neural network.

In some embodiments of the disclosure, optionally, the predetermined rule includes at least one of: a velocity difference suppression rule, whereby when a difference between a desired velocity of the current vehicle and a velocity of a front vehicle in the lane where the current vehicle is located is above a first predetermined value, increasing a probability of performing lane change to an adjacent lane and reducing a probability of keeping the original lane in the initial lane change strategy; a fast lane priority rule, whereby when the probability of keeping the original lane is below a second predetermined value and a difference between a probability of performing lane change to the adjacent left lane and that of performing lane change to the adjacent right lane is below a third threshold in the initial lane change strategy, increasing the probability of performing lane change to the left and reducing the probability of performing lane change to the right; and a decision cooling rule, whereby a lane change to the adjacent lane is restrained in the initial lane change strategy within a predetermined period of time since the last lane change of the current vehicle to the adjacent left lane.

According to another aspect of the disclosure, there is provided a lane change system. The system includes: a receiving unit configured to receive condition information, the condition information including velocity information of a current vehicle, state information of an adjacent vehicle, and lane information; a neural network unit configured to, with the condition information as an input, generate an initial lane change strategy for output; and an expert rule unit configured to correct the initial lane change strategy based on a predetermined rule and the condition information, to generate and output a corrected lane change strategy.

In some embodiments of the disclosure, optionally, the adjacent vehicle includes a neighboring vehicle in the front, rear, left, right, left front, right front, left rear, or right rear in a traveling direction of the current vehicle.

In some embodiments of the disclosure, optionally, the state information includes: a lateral velocity and a longitudinal velocity of the adjacent vehicle, and a lateral distance and a longitudinal distance between the adjacent vehicle and the current vehicle.

In some embodiments of the disclosure, optionally, the lane information includes coefficients of fitting curves of the lane where the current vehicle is located and its adjacent lanes.

In some embodiments of the disclosure, optionally, the neural network unit is composed of a long short-term memory neural network.

In some embodiments of the disclosure, optionally, the predetermined rule includes at least one of: a velocity difference suppression rule, whereby when a difference between a desired velocity of the current vehicle and a velocity of a front vehicle in the lane where the current vehicle is located is above a first predetermined value, increasing a probability of performing lane change to an adjacent lane and reducing a probability of keeping the original lane in the initial lane change strategy; a fast lane priority rule, whereby when the probability of keeping the original lane is below a second predetermined value and a difference between a probability of performing lane change to the adjacent left lane and that of performing lane change to the adjacent right lane is below a third threshold in the initial lane change strategy, increasing the probability of performing lane change to the left and reducing the probability of performing lane change to the right; and a decision cooling rule, whereby a lane change to the adjacent lane is restrained in the initial lane change strategy within a predetermined period of time since the last lane change of the current vehicle to the adjacent left lane.

According to another aspect of the disclosure, there is provided a non-transitory computer-readable medium having instructions for execution by a processor, the instructions when executed by the processor causing the processor to perform the lane change method as described above.

According to another aspect of the disclosure, there is provided a vehicle, including any one of the lane change systems as described above.

### BRIEF DESCRIPTION OF THE SEVERAL VIEWS OF THE DRAWINGS

The above and other objectives and advantages of the disclosure will be more thorough and clearer from the following detailed description in conjunction with the drawings, where the same or similar elements are represented by the same reference numerals.

FIG. 1 shows a lane change method according to an embodiment of the disclosure.

FIG. 2 shows a lane change system according to an embodiment of the disclosure.

FIG. 3 shows a lane changing scenario according to an embodiment of the disclosure.

### DETAILED DESCRIPTION

For the sake of brevity and illustrative purposes, the principles of the disclosure are mainly described herein with reference to its exemplary embodiments. However, those skilled in the art can easily appreciate that the same principle can be equivalently applied to all types of lane change methods, lane change systems, storage media, and vehicles, and a same or similar principle can be implemented therein. These variations do not depart from the true spirit and scope of the disclosure.

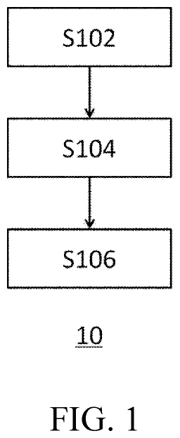

An aspect of the disclosure provides a lane change method. As shown in FIG. 1, the lane change method 10 includes the following steps: receiving condition information in step S102; obtaining an initial lane change strategy with the condition information as an input to a neural network in step S104; and correcting the initial lane change strategy based on a predetermined rule and the condition information in step S106. The lane change strategies of the disclosure include keeping an original lane, performing a lane change to the left, and performing a lane change to the right, with a certain probability for each strategy. In some examples, upon determination of a final strategy, a strategy having the highest probability may be selected for output. It should be noted that the term “correct” herein include a special case of maintaining the original result.

In the lane change method 10 according to some aspects of the disclosure, consecutive frames of condition information, which is, for example, obtained by an image sensor, etc. during a driving process is received in step S102. The condition information includes velocity information of a current vehicle, state information of an adjacent vehicle, and lane information. Herein, the current vehicle refers to a vehicle implementing the lane change method 10, and the adjacent vehicle refers to a vehicle that is near the current vehicle and that may affect a lane change decision. The above condition information received in step S102 is basic data for implementing the lane change method 10. Therefore, reliable condition information is the premise of generating a scientific lane change strategy. It should be noted that the focus herein is lane change in a same direction, and lanes in an opposite direction and vehicles therein are not included in the study.

In some examples, the adjacent vehicle may be a vehicle within a detectable range of an onboard detector (such as a millimeter wave radar, a laser radar, or a vision sensor). Depending on the type and number of the detector, the number of adjacent vehicles within the detectable range may vary. Selecting adjacent vehicles in this way has an advantage of more abundant data, and therefore, decisions may present higher reliability. However, if more adjacent vehicles are considered, there may be a large amount of computation, which may affect decision efficiency.

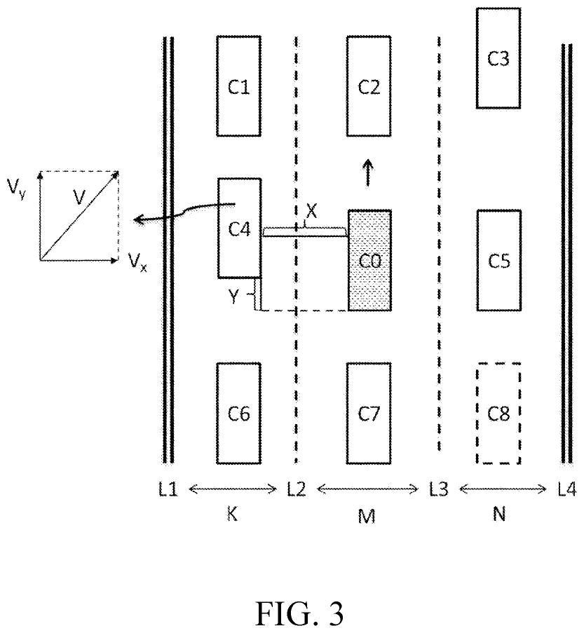

In some embodiments of the disclosure, several vehicles which are the most relevant to lane change can be selected from vehicles within the detectable range of the detector as the adjacent vehicles. For example, as shown in FIG. 3, the adjacent vehicles may be neighboring vehicles in front C2, rear C7, left C4, right C5, left front C1, right front C3, left rear C6, and right rear C8 in a traveling direction (a direction of arrow in front of a vehicle head in the figure) of a current vehicle C0. It should be noted that, the adjacent vehicles here refer to vehicles that may be considered in theory, and the absence of such vehicles in practice would not affect the implementation of the disclosure. For example, if the right-rear neighboring vehicle C8 at the illustrated position is not detected by the detector within a predetermined range, this position is set to be “null” during the implementation of various steps of the disclosure.

In some embodiments of the disclosure, with continued reference to FIG. 3, the state information of the adjacent vehicle includes a lateral velocity and a longitudinal velocity of the adjacent vehicle, and a lateral distance and a longitudinal distance between the adjacent vehicle and the current vehicle. Taking the neighboring vehicle on the left C4 as an example, the neighboring vehicle has a current velocity V, which may be decomposed into a horizontal component Vₓ (the lateral velocity) and a vertical component V_{y} (the longitudinal velocity). There is a lateral distance X and a longitudinal distance Y between the neighboring vehicle on the left C4 and the current vehicle C0. The state information will facilitate description of the state of each adjacent vehicle, from which an accurate lane change strategy can be generated.

In some embodiments of the disclosure, the lane information includes coefficients of fitting curves of the lane where the current vehicle is located and its adjacent lanes (if present). With continued reference to FIG. 3, a lane M where the current vehicle C0 is located shares a lane L2 with a left adjacent lane K, and shares a lane L3 with a right adjacent lane N. The left adjacent lane K also includes a lane L1, and the right adjacent lane N also includes a lane L4. In some examples of the disclosure, the study mainly focuses on the illustrated lanes L1, L2, L3, and L4, and therefore, the lane information includes coefficients of a fitting curve of each of the lanes L1, L2, L3, and L4.

In the lane change method 10 according to some aspects of the disclosure, in step S104, with the condition information as an input to the neural network, the condition information is processed by means of the neural network, to obtain the initial lane change strategy. Before the neural network is used to process the data input in real time and generate the initial lane change strategy, the neural network may be trained by using human driving empirical data. Related training processes may be carried out according to the existing technology, and details are not repeated here.

In some embodiments of the disclosure, the initial lane change strategy is generated by using a long short-term memory (LSTM) neural network in step S104. The long short-term memory neural network is a special type of recurrent neural network (RNN). Compared with general recurrent neural networks, the long short-term memory neural network may have a better performance for a longer sequence. The inventors have found during the process of research and development that compared with other types of neural networks, the long short-term memory neural network achieves a better effect in processing a vehicle autonomous lane change strategy, which allows for both a higher efficiency, and a more satisfactory lane change strategy to be generated.

In the lane change method 10 according to some aspects of the disclosure, in step S106, the initial lane change strategy is corrected based on the predetermined rule and the condition information, to generate and output the corrected lane change strategy. After the probability of the initial lane change strategy (e.g., keeping going straight, performing a lane change to the left or right) executed by the current vehicle in a real-time environment is obtained through step S104, a value of the probability may be further processed by a customized expert system. The expert system may optimize the result generated in step S104 by using existing knowledge or by experience, thereby achieving a better solution to complex decision problems. Specifically, the expert system may optimize the output lane change decision on the basis of the result output by the neural network in combination with intuitive driving experience of humans during driving.

The use of the expert system has an advantage of allowing for customized addition, modification, or deletion of in-system experience, thereby making the intelligent lane change decision output more adapt to an expectation of a driver, and also more conducive to maintenance and iteration of a decision machine.

In some embodiments of the disclosure, the predetermined rule mentioned in step S106 may include the following contents.

(1) Velocity difference suppression rule. The neural network uses driving data of human drivers for learning. For different drivers, there may be different conditions for lane change when there is a slow vehicle ahead. When processing a lane change probability given by the neural network, the expert system may first define the decision scenario as “there is a vehicle ahead, and a difference between the velocity of that vehicle and a desired driving velocity of the current vehicle is greater than a certain threshold for a certain period of time”. The desired driving velocity of the current vehicle may be a representation of the current cruise velocity set by a driver. If a velocity difference suppression condition is met, a probability of each output of the neural network may be revised. For example, for a scenario where a velocity difference from the vehicle ahead is large, a probability of performing a lane change to the left/right is appropriately increased, and a probability of going straight is reduced. Specifically, when a difference between a desired velocity of the current vehicle and a velocity of a front vehicle in the lane where the current vehicle is located is above a first predetermined value, a probability of performing a lane change to an adjacent lane is increased and a probability of keeping an original lane is reduced in the initial lane change strategy.

(2) Fast lane priority rule. When a probability that the output of the neural network indicates performing a lane change to one side is far greater than those of the other two outputs, it may be considered that most drivers select to perform a lane change to this side in this scenario, and the expert system then selects this direction as a lane change decision for output. When a probability that the output of the neural network indicates going straight is extremely low, but probabilities of performing a lane change to both sides are equal, it may be considered that performing a lane change to the left or right adapts to an expectation of the driver. Considering that the left lane is taken as a fast lane on most roads, and there may be a slow vehicle ahead in a right lane that has not been observed, the expert system may appropriately increase the probability of the output indicative of performing a lane change to the left, and reduce the probability of the output indicative of performing a lane change to the right, so that the overall decision tends to indicate driving to the fast lane. Specifically, when the probability of keeping the original lane is below a second predetermined value and a difference between a probability of performing a lane change to an adjacent left lane and that of performing a lane change to an adjacent right lane is below a third threshold in the initial lane change strategy, the probability of performing a lane change to the left is increased and the probability of performing a lane change to the right is reduced.

(3) Decision cooling rule. During driving, due to switching of the current vehicle between various states, there are some scenarios where frequent lane change decision making is undesired even though conditions for triggering intelligent lane change are met. For example, when the vehicle has just completed a lane change action, another lane change action at this time may increase the driver's sense of insecurity. For such a scenario, the expert system may perform identification during operation, and set a cooling time based on each scenario type. Within the cooling time, the intelligent lane change decision may be restrained by the expert system even though a driving scenario meets the condition. Specifically, a lane change to the adjacent lane is restrained in the initial lane change strategy within a predetermined period of time since the last lane change of the current vehicle to the adjacent left lane.

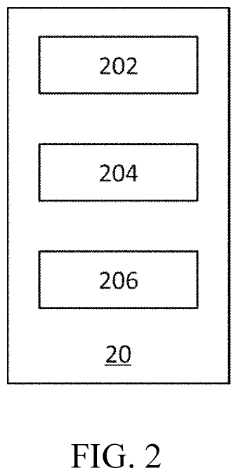

Another aspect of the disclosure provides a lane change system. As shown in FIG. 2, the lane change system 20 includes a receiving unit 202, a neural network unit 204, and an expert rule unit 206. Although shown to be separate in the figure, the unit modules may be integrated. For example, the neural network unit 204 and the expert rule unit 206 may be implemented by using a special-purpose or general-purpose processor (assisted with a necessary storage device).

The receiving unit 202 of the lane change system 20 is configured to receive consecutive frames of condition information, which is, for example, obtained by an image sensor, etc. during a driving process, the condition information including velocity information of a current vehicle, state information of an adjacent vehicle, and lane information. Herein, the current vehicle may refer to a vehicle to which the lane change system 20 belongs, and the adjacent vehicle refers to a vehicle that is near the current vehicle and that may affect a lane change decision. The above condition information received by the receiving unit 202 is basic data for continuous operation of the lane change system 20. Therefore, reliable condition information is the premise of generating a scientific lane change strategy. It should be noted that the focus herein is lane change in a same direction, and lanes in an opposite direction and vehicles therein are not included in the study.

In some examples, the adjacent vehicle may be a vehicle within a detectable range of an onboard detector (such as a millimeter wave radar, a laser radar, or a vision sensor). Depending on the type and number of the detector, the number of adjacent vehicles within the detectable range may vary. Selecting adjacent vehicles in this way has an advantage of more abundant data, and therefore, decisions may present higher reliability. However, if more adjacent vehicles are considered, there may be a large amount of computation, which may affect decision efficiency.

In some embodiments of the disclosure, the lane change system 20 may select, from vehicles within the detectable range of a vehicle detector (not shown in the figure), several vehicles, which are the most relevant to lane change, as the adjacent vehicles. For example, as shown in FIG. 3, the adjacent vehicles may be neighboring vehicles in front C2, rear C7, left C4, right C5, left front C1, right front C3, left rear C6, and right rear C8 in a traveling direction (a direction of arrow in front of a vehicle head in the figure) of a current vehicle C0. It should be noted that, the adjacent vehicles here refer to vehicles that may be considered in theory, and the absence of such vehicles in practice would not affect the implementation of the disclosure. For example, if the right-rear neighboring vehicle C8 at the illustrated position is not detected by the detector within a predetermined range, the lane change system 20 may set this position to be “null”.

In some embodiments of the disclosure, with continued reference to FIG. 3, the state information of the adjacent vehicle includes a lateral velocity and a longitudinal velocity of the adjacent vehicle, and a lateral distance and a longitudinal distance between the adjacent vehicle and the current vehicle. Taking the neighboring vehicle on the left C4 as an example, the neighboring vehicle has a current velocity V, which may be decomposed into a horizontal component Vₓ (the lateral velocity) and a vertical component V_{y} (the longitudinal velocity). There is a lateral distance X and a longitudinal distance Y between the neighboring vehicle on the left C4 and the current vehicle C0. The state information will facilitate description of states of each adjacent vehicle, from which the lane change system 20 can then generate an accurate lane change strategy.

In some embodiments of the disclosure, the lane information includes coefficients of fitting curves of the lane where the current vehicle is located and its adjacent lanes (if present). With continued reference to FIG. 3, a lane M where the current vehicle C0 is located shares a lane line L2 with a left adjacent lane K, and shares a lane L3 with a right adjacent lane N. The left adjacent lane K also includes a lane L1, and the right adjacent lane N also includes a lane L4. In some examples of the disclosure, the study mainly focuses on the illustrated lanes L1, L2, L3, and L4, and therefore, the lane information considered by the lane change system 20 includes coefficients of a fitting curve of each of the lanes L1, L2, L3, and L4.

The neural network unit 204 of the lane change system 20 is configured to, with the condition information as an input, generate an initial lane change strategy for output. Before the neural network unit 204 is used to process the data input in real time and generate the initial lane change strategy, the neural network unit 204 may be trained by using human driving empirical data. Related training processes may be carried out according to the existing technology, and details are not repeated here.

In some embodiments of the disclosure, the neural network unit 204 is composed of a long short-term memory neural network. The long short-term memory neural network is a special type of recurrent neural network. Compared with general recurrent neural networks, the long short-term memory neural network may have a better performance for a longer sequence. The inventors have found during the process of research and development that compared with other types of neural networks, the long short-term memory neural network achieves a better effect in processing a vehicle autonomous lane change strategy, which allows for both a higher efficiency, and a more satisfactory lane change strategy to be generated.

The expert rule unit 206 of the lane change system 20 is configured to correct the initial lane change strategy based on a predetermined rule and the condition information, to generate and output a corrected lane change strategy. After the probability of the initial lane change strategy (e.g., keeping going straight, performing a lane change to the left or right) executed by the current vehicle in a real-time environment is obtained by the neural network unit 204, a value of the probability may be further processed by the customized expert rule unit 206. The expert rule unit 206 may optimize the result generated by the neural network unit 204 by using existing knowledge or by experience, thereby achieving a better solution to complex decision problems. Specifically, the expert rule unit 206 may optimize the output lane change decision on the basis of the result output by the neural network unit 204 in combination with intuitive driving experience of humans during driving.

The use of the expert system has an advantage of allowing for customized addition, modification, or deletion of in-system experience, thereby making the intelligent lane change decision output more adapt to an expectation of a driver, and also more conducive to maintenance and iteration of a decision machine.

In some embodiments of the disclosure, the predetermined rule used by the expert rule unit 206 may include the following aspects. (1) Velocity difference suppression rule. For basic principles of this rule, reference may be made to the above description, and details are not repeated here. Specifically, when a difference between a desired velocity of the current vehicle and a velocity of a front vehicle in the lane where the current vehicle is located is above a first predetermined value, a probability of performing a lane change to an adjacent lane is increased and a probability of keeping an original lane is reduced in the initial lane change strategy. (2) Fast lane priority rule. For basic principles of this rule, reference may be made to the above description, and details are not repeated here. Specifically, when the probability of keeping the original lane is below a second predetermined value and a difference between a probability of performing a lane change to an adjacent left lane and that of performing a lane change to an adjacent right lane is below a third threshold in the initial lane change strategy, the probability of performing a lane change to the left is increased and the probability of performing a lane change to the right is reduced. (3) Decision cooling rule. For basic principles of this rule, reference may be made to the above description, and details are not repeated here. Specifically, a lane change to the adjacent lane is restrained in the initial lane change strategy within a predetermined period of time since the last lane changing of the current vehicle to the adjacent left lane.

Another aspect of the disclosure provides a vehicle including any one of the lane change systems as described above. The vehicle equipped with the lane change system may achieve intelligent, safe and efficient lane change during an autonomous driving or driving assistance process.

According to another aspect of the disclosure, there is provided a non-transitory computer-readable medium having instructions for execution by a processor, the instructions when executed by the processor causing the processor to perform the lane change methods as described above. The non-transitory computer-readable medium in the disclosure includes various types of computer storage media, and may be any usable medium accessible to a general-purpose or special-purpose computer. For example, the non-transitory computer-readable medium may include a RAM, a ROM, an EPROM, an EEPROM, a register, a hard disk, a removable hard disk, a CD-ROM or another optical memory, a magnetic disk memory or another magnetic storage device, or any other transitory or non-transitory media that can carry or store expected program code having an instruction or data structure form and be accessible to the general-purpose or special-purpose computer or a general-purpose or special-purpose processor. Data is usually copied magnetically in a disk used herein, while data is usually copied optically by using lasers in a disc. A combination thereof shall also fall within the scope of protection of the non-transitory computer-readable media. An exemplary storage medium is coupled to a processor, so that the processor can read information from and write information to the storage medium. In an alternative solution, the storage medium may be integrated into the processor. The processor and the storage medium may reside in an ASIC. The ASIC may reside in a user terminal. In an alternative solution, the processor and the storage medium may reside as discrete assemblies in a user terminal.

Some of the above examples of the disclosure provide solutions to making an intelligent lane change decision for an autonomous vehicle in a complex driving environment. According to the solutions, an intelligent and safe lane change decision may be automatically generated based on current lane information, a continuous operating state of a surrounding vehicle, a continuous operating state of a current vehicle, etc. A control system of an autonomous driving system may implement a lane change action according to this lane change decision.

The foregoing descriptions are merely the embodiments of the disclosure, but are not intended to limit the scope of protection of the disclosure. Any feasible variation or replacement conceived by a person skilled in the art within the technical scope disclosed in the disclosure shall fall within the scope of protection of the disclosure. Without conflicts, the embodiments of the disclosure and features in the embodiments may also be combined with each other. The scope of protection of the disclosure shall be subject to recitations of the claims.

What is claimed is:

1. A lane change method, comprising the following steps:
receiving condition information, the condition information comprising velocity information of a current vehicle, state information of an adjacent vehicle, and lane information;
with the condition information as an input to a neural network, processing the condition information by means of the neural network, to obtain an initial lane change strategy; and
correcting the initial lane change strategy based on a predetermined rule and the condition information, to generate and output a corrected lane change strategy.

2. The method according to claim 1, wherein the adjacent vehicle comprises a neighboring vehicle in the front, rear, left, right, left front, right front, left rear, and right rear in a traveling direction of the current vehicle.

3. The method according to claim 1, wherein the state information comprises: a lateral velocity and a longitudinal velocity of the adjacent vehicle, and a lateral distance and a longitudinal distance between the adjacent vehicle and the current vehicle.

4. The method according to claim 1, wherein the lane information comprises coefficients of fitting curves of the lane where the current vehicle is located and its adjacent lanes.

5. The method according to claim 1, wherein the neural network is a long short-term memory neural network.

6. The method according to claim 1, wherein the predetermined rule comprises at least one of:
a velocity difference suppression rule, whereby when a difference between a desired velocity of the current vehicle and a velocity of a front vehicle in the lane where the current vehicle is located is above a first predetermined value, increasing a probability of performing lane change to an adjacent lane and reducing a probability of keeping the original lane in the initial lane change strategy;
a fast lane priority rule, whereby when the probability of keeping the original lane is below a second predetermined value and a difference between a probability of performing lane change to the adjacent left lane and that of performing lane change to the adjacent right lane is below a third threshold in the initial lane change strategy, increasing the probability of performing lane change to the left and reducing the probability of performing lane change to the right; and
a decision cooling rule, whereby a lane change to the adjacent lane is restrained in the initial lane change strategy within a predetermined period of time since the last lane change of the current vehicle to the adjacent left lane.

7. A non-transitory computer-readable medium having instructions for execution by a processor, the instructions when executed by the processor causing the processor to perform the lane change method, comprising:
receiving condition information, the condition information comprising velocity information of a current vehicle, state information of an adjacent vehicle, and lane information;
with the condition information as an input to a neural network, processing the condition information by means of the neural network, to obtain an initial lane change strategy; and
correcting the initial lane change strategy based on a predetermined rule and the condition information, to generate and output a corrected lane change strategy.

8. The non-transitory computer-readable medium according to claim 7, wherein the adjacent vehicle comprises a neighboring vehicle in the front, rear, left, right, left front, right front, left rear, or right rear in a traveling direction of the current vehicle.

9. The non-transitory computer-readable medium according to claim 7, wherein the state information comprises: a lateral velocity and a longitudinal velocity of the adjacent vehicle, and a lateral distance and a longitudinal distance between the adjacent vehicle and the current vehicle.

10. The non-transitory computer-readable medium according to claim 7, wherein the lane information comprises coefficients of fitting curves of the lane where the current vehicle is located and its adjacent lanes.

11. The non-transitory computer-readable medium according to claim 7, wherein the neural network unit is composed of a long short-term memory neural network.

12. The non-transitory computer-readable medium according to claim 7, wherein the predetermined rule comprises at least one of:
a velocity difference suppression rule, whereby when a difference between a desired velocity of the current vehicle and a velocity of a front vehicle in the lane where the current vehicle is located is above a first predetermined value, increasing a probability of performing lane change to an adjacent lane and reducing a probability of keeping the original lane in the initial lane change strategy;
a fast lane priority rule, whereby when the probability of keeping the original lane is below a second predetermined value and a difference between a probability of performing lane change to the adjacent left lane and that of performing lane change to the adjacent right lane is below a third threshold in the initial lane change strategy, increasing the probability of performing lane change to the left and reducing the probability of performing lane change to the right; and
a decision cooling rule, whereby a lane change to the adjacent lane is restrained in the initial lane change strategy within a predetermined period of time since the last lane change of the current vehicle to the adjacent left lane.

13. A vehicle, comprising a processor and a memory, wherein the memory stores a plurality of program codes, and the program codes are loaded and run by the processor to perform a lane change method, the method comprising the following steps:
receiving condition information, the condition information comprising velocity information of a current vehicle, state information of an adjacent vehicle, and lane information;
with the condition information as an input to a neural network, processing the condition information by means of the neural network, to obtain an initial lane change strategy; and
correcting the initial lane change strategy based on a predetermined rule and the condition information, to generate and output a corrected lane change strategy.
